(19) United States
(12) Patent Application Publication
(10) Pub. No.: US 2016/0363113 A1
(43) Pub. Date: Dec. 15, 2016

(54) Friction-free Rotary Piston Scissor Action Motor / Hot Air Energy Generator

(71) Applicant: Zheng Huang, Toledo, OH (US)

(72) Inventor: Zheng Huang, Toledo, OH (US)

(21) Appl. No.: 14/734,133

(22) Filed: Jun. 9, 2015

(51) Int. Cl. F03G 6/06; F01C 1/14; F01C 21/08; F01C 21/10; F01C 21/18; F03G 6/04; F01C 21/00

(52) U.S. Cl. CPC F03G 6/06; F03G 6/045; F01C 1/14; F01C 21/008; F01C 21/10; F01C 21/18; F01C 21/08

(57) ABSTRACT

Many versions of scissor-action engines have existed. All such prior scissor-action engine designs have used rotary reciprocal movement between the rotary piston members. The present invention uses two rotary scissor-action piston members symmetrically separating the housing cylinder into two pairs of air chambers. Two pairs of air intakes and air exhausts are strategically positioned in relationship to the two air chambers. A paired gear transmission mechanism, called a “Butterfly Gear”, is linked to the rotors to control scissor action. This invention design is a “friction-free” rotary piston and momentum exchanging spring mechanism, allowing the rotary members to rotate at high speed like a turbine blade; thus resulting in higher efficiency, by reducing energy loss from air leaking and friction. Rotary scissor-action air motors can be rotated in reverse to operate as a compressor. The invention design is a system utilizing a heat exchanger container connected with two Rotary Scissor Action Motors; one as a compressor and the second as an air motor to generate energy from hot air. “The Hot Air Generator” can use concentrated sunlight or any other heating source.

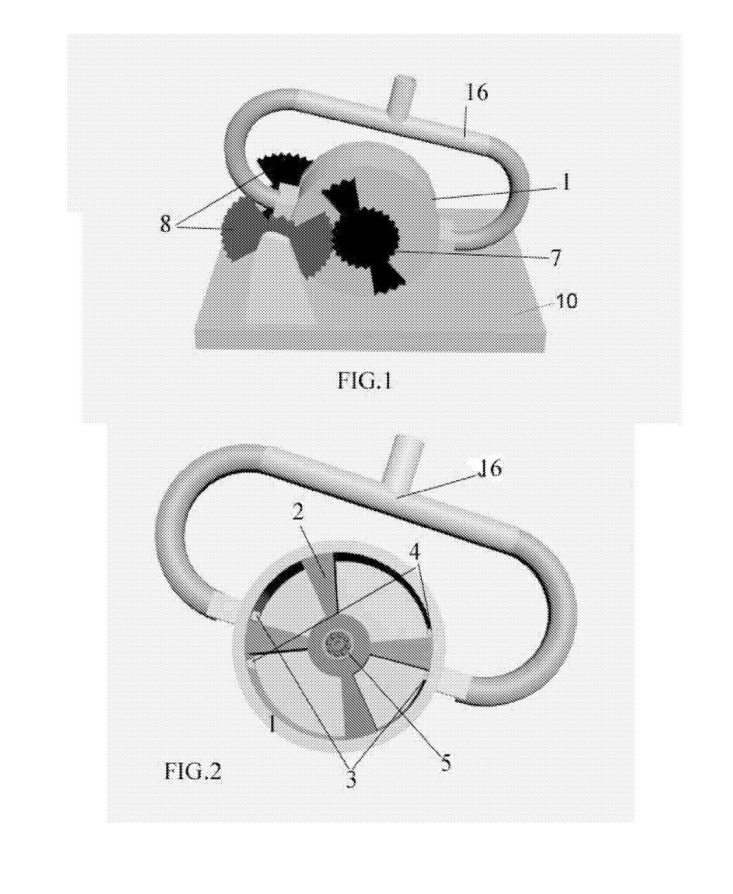

FIG. 1 & 2: Two rotary scissor-action piston members symmetrically separate the housing cylinder into two pairs of air chambers. Two pairs of air intakes and air exhausts are strategically positioned in relationship to the pressuring chambers and exhausting chambers. The outer wall of the piston members function as valves to open and close air intake and exhaust ports while it's rotating. The positioning of the intake and exhaust ports controls the timing of the air input and exhaust. Piston members rotate 180 degree on each cycle.

FIG. 3 & 4: The invention design is a freely moving pair of scissor-action pistons called a “friction-free” piston. There is a bearing ring (6) set in-between the slots of two piston rotor surfaces; and there is a bearing (5) on each axle of the rotor to support the weight of rotary piston. There is no physical contact between housing and the piston members, resulting in a friction-free design. This enables the rotary piston members to rotate at high speed, like turbine blades, leaving less time for air leakage through the gap between the housing wall and each piston member, thus eliminating the usage of vanes for sealing yet still maintaining high efficiency.

FIG. 5 & 6: In order to reduce vibration and the loss of efficiency in passing the momentum from the fast moving rotary member to the slow moving rotary member, a set of springs are placed on one side of each wing of the rotary members. The position of the springs can be adjusted to reach an optimal motion balance. The springs could be coiled, bended arc, or different shapes; and embedded or mounted by different methods.

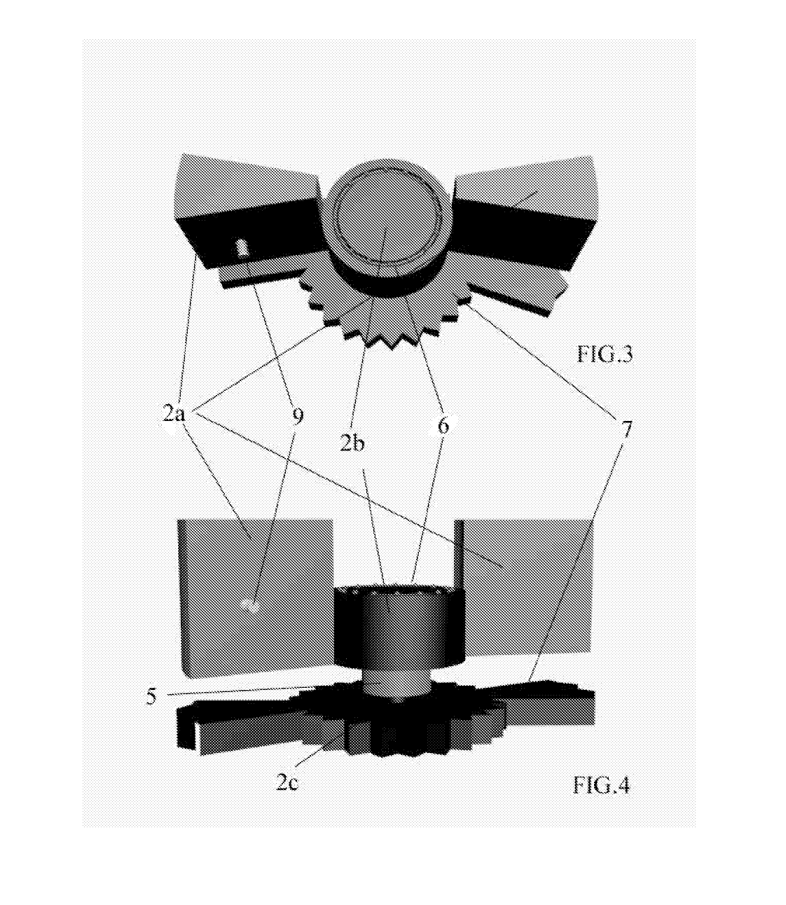

As shown in FIG. 2: All the parts: including air intake (3) and exhaust (4) ports, piston members (2), pressure and exhaust chambers, and Butterfly Gears are symmetrically designed. This makes the pressure of the four chambers equalized and balanced with less vibration when rotating.

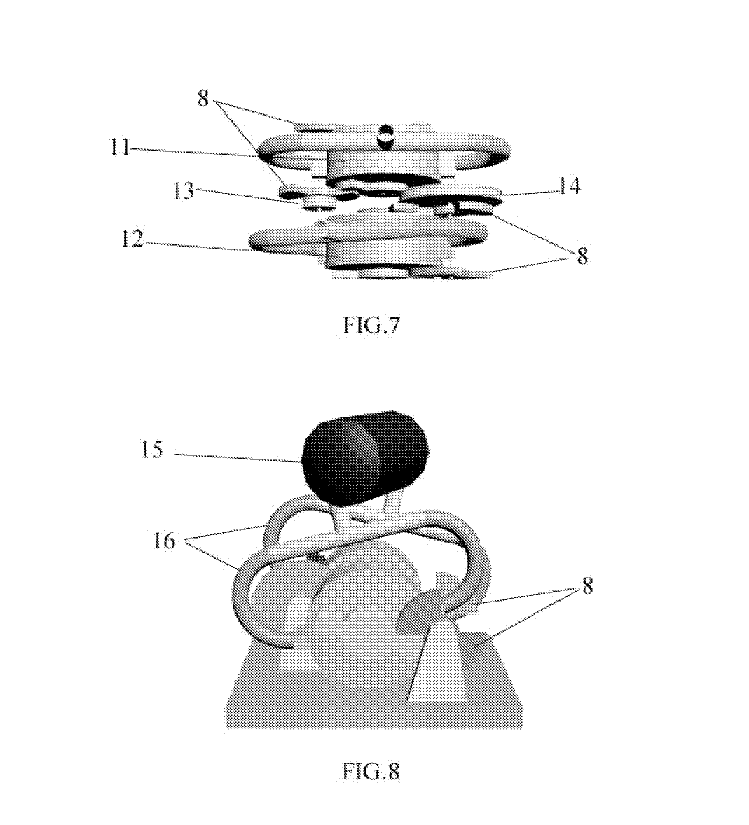

FIG. 7 & 8: Rotary scissor-action motor can be rotated in reverse to operate as a compressor (12). A heat exchange container connects with two rotary scissor-action motors; one of which works as a compressor (12) and the other works as an air motor (11). This combination becomes a Hot Air Energy Generator. It generates motion energy by compressing cool air into the heat exchange container (15), which can be heated up by concentrated sunlight or any other heat source, and expanding the air into the air motor (11) through the tube (16) to produce work. Compressor (12) is driven by the air motor; which is connected with a large pulley (14) and a small pulley (13) via a transmission belt. The minimum portion of the driving force needed from the air motor back to the compressor decides the ratio of the dimension of two pulleys.

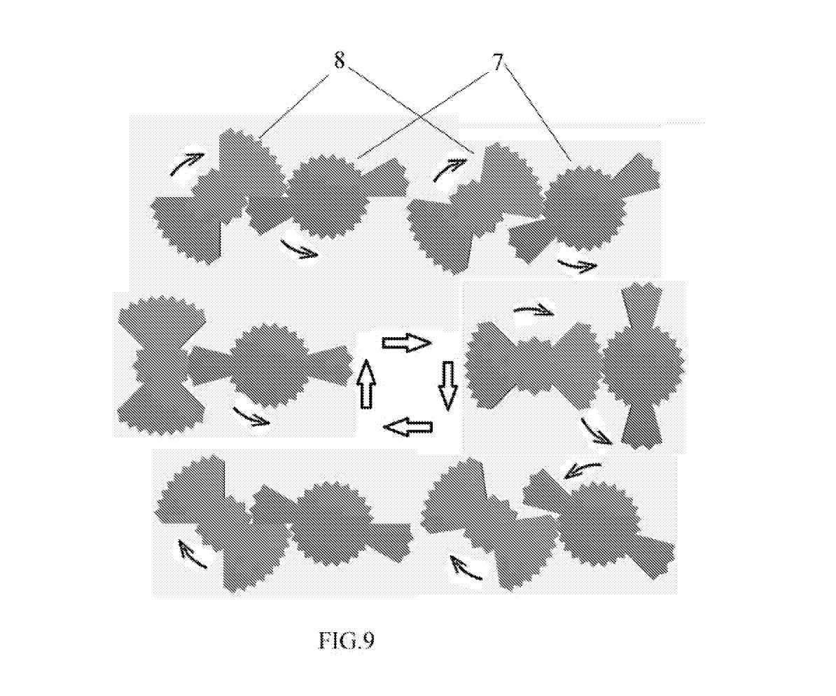

FIG. 9: Shows the animation of one cycle motion of the Butterfly Gear. Butterfly Gears consist of a pair of driving gears (7) and a pair of transmission gears (8) The unique “butterfly” shapes of gears allow simultaneously changing the gear ratio while it's rotating. While transmission gear (8) is always rotating at a constant angle speed, driving gears (7) will shift alternatingly from low to high angle speed resulting in the scissor motion. The pair of driving gears is mounted on the axle of each of the piston rotors, and transmission gears are perpendicularly mounted on another axle. They are linked together transmitting torque from one piston, through its driving gear, to another piston.

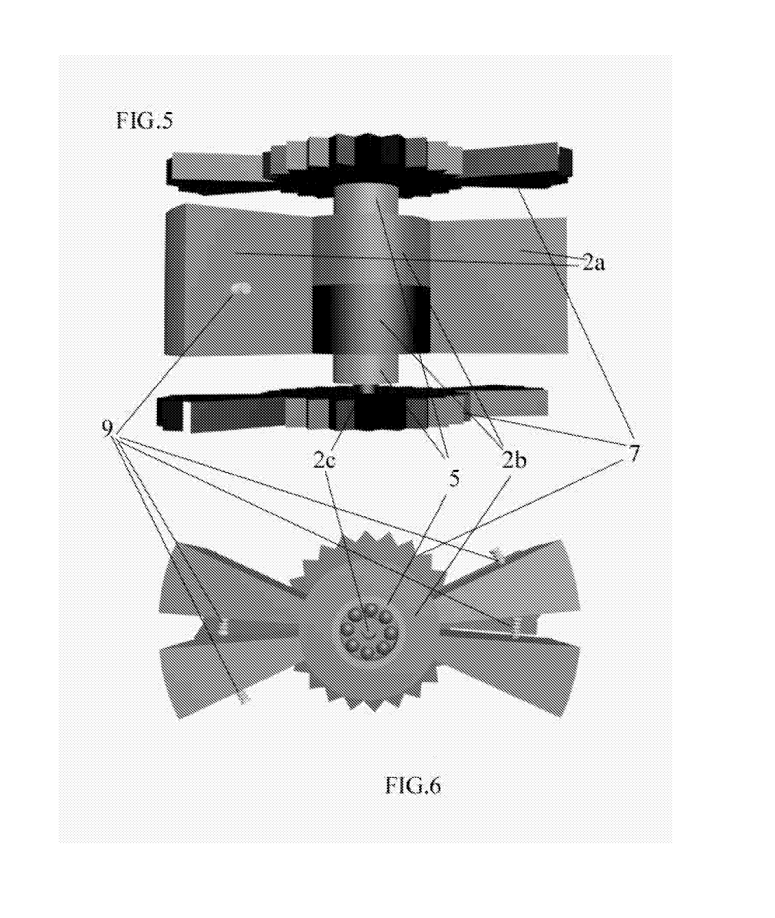

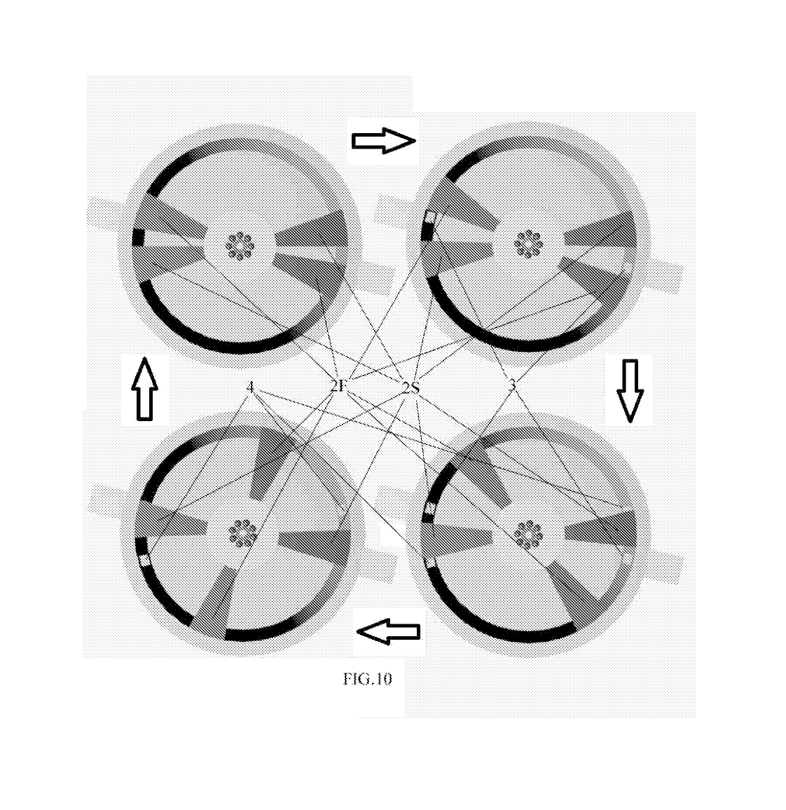

FIG. 10: Shows two pairs of scissor-action pistons, one rotating at high speed while another moving at low speed and exchange relative speed at every cycle. There are two cycles per each revolution. The cycle starts with piston member (2F) rotating to about five degree and opening the air intake (3). Then hot high-pressure air goes into the pressuring chamber and pushes the piston member (2F), thus rotating towards the exhaust chamber. Simultaneously, the slow moving piston member (2S) opens the exhaust to let the air out. Intake (3) will be closed by piston member (2S) to stop air from entering in when piston member (2F) rotates to about the half cycle. Hot high pressure air in the pressure chamber keeps expanding during the rest of the cycle until piston member (2F) rotates to 180 degree to open the exhaust for the pressure chamber member. This gives enough space for hot air expansion, and enables the piston member (2F) to absorb the maximum energy from the expanding air before it is exhausted. Piston member (2S), now moving relatively slower, opens exhaust at the beginning of the cycle; then closing the air intake (3) when member (2F) rotates to about half cycle being driven by the butterfly gears. The force to drive member (2S) comes from member (2F) through a paired gear transmission mechanism, called Butterfly Gears, see (7) on FIG. 6; which are linked to the axles of both piston members to control the timing and scissor motion.

### DRAWINGS

Rotary scissor action motor includes the following, which are referenced in the figures:

```
  1 - Housing
  2 - Rotary piston
  2a - Piston member
  2b - Piston rotor
  2c - Piston axle
  3 - Air intake
  4 - Air exhaust
  5 - Bearing
  6 - Bearing ring
  7 - Butterfly driving gear
  8 - Butterfly transmission gear
  9 - Bouncing spring
10 - Base
11 - Air motor
12 - Compressor
13 - Small transmission pulley
14 - Large transmission pulley
15 - Heat exchange tank
16 - Air tubing
```

I claim:

(1) Friction-free rotary piston scissor-action motor is comprised of two friction-free rotary pistons, bearing support, bouncing spring momentum exchange mechanism, Butterfly Gear driven mechanism and housing with two pairs of symmetrical placed intake and exhaust ports.

(2) Butterfly Gear driven mechanism, as defined in claim 1, comprised of a paired butterfly shape gear, including a pair of driving gears, which are mounted on the axle of each piston rotor, and two transmission gears, which are perpendicularly mounted on another axle; transmits torque from one piston, through its driving gear to transmission gear, to another piston.

(3) Butterfly Gears, as defined in claim 2, have the unique “Butterfly” shapes' which allow the pair of gears to simultaneously change the gear ratio from low to high and vice versa while the Butterfly Gear is rotating

(4) While transmission gear, as defined in claim 2, is always rotating at a constant angle speed; two driving gears, as defined in claim 2, will shift from high to low angle speed alternately, resulting in the scissor action of the piston.

(5) Friction-free rotary pistons, as defined in claim 1, consists of a bearing ring between the slots of two rotor surfaces and a bearing on both axles to support the piston's weight; thus there is no physical contact between the housing and each of the piston members, having no vane to seal the pistons.

(6) The bouncing spring momentum exchange mechanism, as defined in claim 1, comprises of a set of springs placed on one side of each wing of rotary members designed to reduce vibration' and also designed to efficiently pass momentum from the fast moving rotary member to the slow moving rotary member during the scissor action. .

(7) Friction-free rotary pistons , as defined in claim 5, and bouncing spring momentum exchange mechanism, as defined in claim 6, enable pistons to rotate at high speed like turbine blade leaving less time for air leakage, thus eliminating the need to use vanes for sealing; yet still maintain high efficiency.

(8) The springs, as defined in claim 6, can be coiled, bended arc, or different shapes; and embedded or mounted with different methods.

(9) The positioning of the intake and exhaust ports on the housing, as defined in claim 1, are set apart at about 20 degree angle, to control the timing of the air input and air exhaust, which is on the outside of the slow moving piston member and closes the intake when the fast moving member rotates to about half-way;
thus letting the air to keep expanding in the chamber which pushes on the members resulting in the maximum transfer of momentum.

(10) All the parts, as, defined in claim 1, including the air intake, exhaust ports, rotary piston members, pressure and exhaust chambers, and Butterfly Gears consists of symmetrically distributed and balanced components, which enable the high speed rotation with minimum vibration.

(11) Friction-free rotary piston scissor-action motor, as defined in claim 1, can be rotated in reverse to operate as a compressor.

(12) Hot air energy generator, as defined in claim 1, comprised of two friction-free rotary piston scissor-action motors; where one works as a compressor, as defined in claim 1, and the other as an air motor; both of which are connected with a heat exchange container to generate motion energy by compressing cool air into a heat exchange container which can be heated up by concentrated sunlight or any other heat source, and expand into the air motor to produce work.

(13) The compressor, as defined in claim 11, is driven by the air motor via a belt through pulleys linked on transmission gear of each motor, as defined in claim 2;
with the ratio of the dimension of two pulleys decided by the minimum portion of driving force needed from air motor back to compressor.

(14) The driving transmission methods from air motor to compressor, as defined in claim 13, can use gears or any driving mechanisms.
